(19) United States
(12) Patent Application Publication
(10) Pub. No.: US 2006/0038655 A1
(43) Pub. Date: Feb. 23, 2006

(54) Method and device for securing devices against unauthorized access, particularly for identifying in a casino

(76) Inventor: Rudolf Hauke, Niederstotzingen (DE)

Correspondence Address: Davidson Davidson & Kappel, 485 Seventh Avenue, 14th floor, New York, NY, 10018, US

(21) Appl. No.: 10/535,109

(22) PCT Filed: Jul. 4, 2003
(86) PCT No.: PCT/DE03/02243

§ 371 Date: May 16, 2005

(51) Int. Cl. G05B 19/00

(52) U.S. Cl. 340/5.52; 340/5.53; 340/5.61; 463/29

(57) ABSTRACT

A method for securing facilities against access of unauthorized persons, in particular for verifying the access authorization of gamblers to gambling machines in a casino, wherein biometric data of the persons are analyzed, characterized in that every person possesses a document in which biometric data of its owner are applied on a carrier material, the carrier material containing at least one identifiable body whose data are touchlessly acquired by an acquisition unit within a certain operating range and transferred to at least one facility, wherein the facility automatically loads the biometric data of all persons located within the operating range from a central memory storage into a device internal memory storage, and that an identification of the person as well as of the authorization to possess the document is performed at the facility.

The invention relates to a method and an apparatus for securing facilities against access of unauthorized persons, in particular for verifying the access authorization of gamblers to gambling machines in a casino, wherein biometric data of the persons are analyzed.

In manifold applications, security systems are used to refuse access to certain areas or facilities to unauthorized persons. Such areas are, for example, gambling machines in casinos, cash machines, laboratory premises to be kept secret and the like. Thereby, it is also known to use facilities for acquiring biometric data.

Here, an important measure is to prevent the misuse of data media provided with cash value.

For this, according to DE 198 42 355, a method for encashing an amount for the authorized use of an area and/or a service is known, where the unauthorized use of a data medium is prevented by storing data in a data terminal at the beginning of use and calculating the amount payable for the period of use after the termination of use, wherein a value transponder containing an individual identification number and a certain debitable amount is linked to a read/write station of the data terminal and a deposit amount on the value transponder is blocked at the beginning of use and the amount calculated for the period of use is debited and the blocking of the deposit amount is canceled after termination of use. This way it can be achieved that no reverse postings onto the transponder, but only a release of blockings at simultaneous fee debits are carried out at the voucher machine. Thus, manipulations in order to unjustifiedly withdraw money are impossible.

Here, it is disadvantageous that the user has to connect to the data terminal several times and that he is not protected against loss of the value transponder nor its unauthorized use.

In WO 02/47042, a system to operate gambling machines in a casino is described, where biometric data of users are stored in a computer and the access authorization of the gamblers is verified using these data.

In this case, it is disadvantageous that this system is not suitable for a larger number of users, because the very large amounts of data to be verified require a too large expenditure of time.

The invention is underlied by the problem to specify a method and an apparatus of the kind initially mentioned, by which a high security is assured for the unauthorized use of facilities. The invention shall enable a cost-effective and fast verification and avoid to a large extent verification processes that burden the user.

According to the invention, the problem is solved by a method comprising the attributes given in claim 1.

Advantageous embodiments are given in the dependent claims.

The method according to the invention enables to carry out a preselection of data from a large database very fast and cost-effective. For example, the data of 50 000 gamblers can be stored in a central database and from there, a gambling machine gathers the datasets of the gamblers located in its vicinity which will be a very much smaller quantity, so even in the case of a number of 500 gamblers these data can be analyzed within less than one second without problems.

In the following, the invention is further explained considering an embodiment as an example. The example describes the process in a casino with a plurality of gamblers and gambling machines.

In the appropriate drawings, it is shown by:

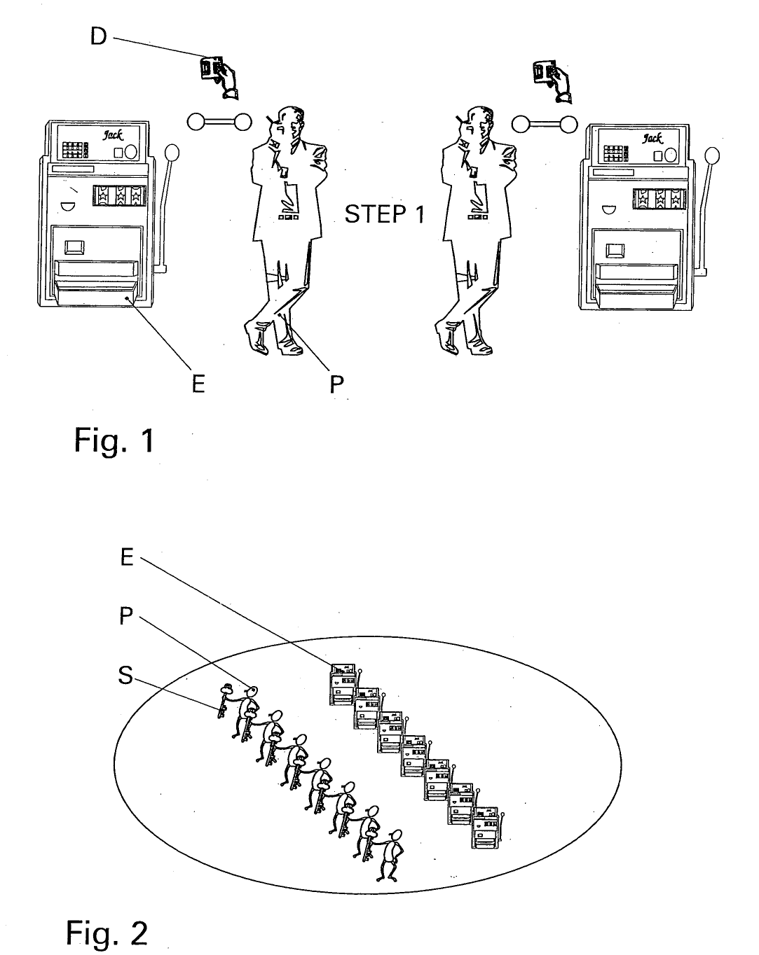

FIG. 1 the process of registering a gambler,

FIG. 2 the finger identification and the assignment of the gamblers to the gambling machines located within reach,

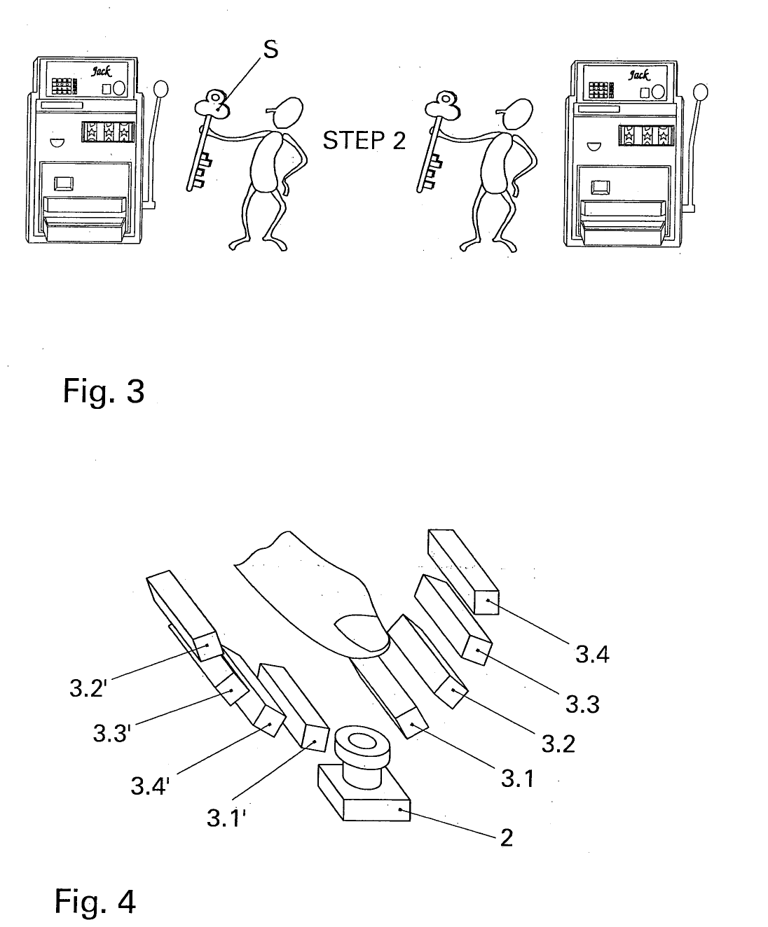

FIG. 3 the start of a game by touchless finger identification and

FIG. 4 a schematic representation of an arrangement for touchlessly acquiring a finger by means of two detectors.

In FIG. 1, two persons P are depicted who possess as a document D, respectively, a gambler identity card on which a photograph and a fingerprint of the persons P are mounted and which is provided with a radio chip. If the person P approaches the facility E, i. e. in the case under consideration the gambling machine, the biometric data of the gambler are loaded by the gambling machine as soon as the range of its radio chip being mounted on the document D detects the gambling machine. If the person P departs from the radio range these data are deleted automatically. The gambling machine thus has the relevant data of all persons P being located within the radio range at its disposal.

In FIG. 2, there is illustrated the finger identification and the assignment of the biometric data of all gamblers located within reach to the gambling machines arranged there.

The start of a game shown in FIG. 3 is performed by means of the key S which becomes operative by touchless identification of a finger of a person P.

FIG. 4 explains the basic way of operation of a facility for fraud-proof verification by simultaneously acquiring two partial images of the finger 1 from different directions. The position of the finger is defined by the coordinates x, y, z in a Cartesian coordinate system. As shown in this illustration, this finger is simultaneously acquired from a different angle of view in addition to the detector 2.1 which is located in the x-y plane and acquires the image of the finger 1 in z-direction, wherein this image results from laying onto a sensor or, preferably, from imaging. Preferably, the directions of imaging, from which the object is observed, form an angle of 90 degrees and lie in one plane. This means, that the angles φ and δ between the direction of taking and a coordinate direction running through the finger's axis as y-axis, which are depicted in FIG. 1, have a value of 90°. A second image is taken in x-direction by the detector 2.2 which is located in the y-z plane.

The function values are compared to data of reference functions which exhibit an identical data structure and are stored in a data base.

The reference functions, then, look like
R_{xy}(x, y, m_{xy}) for the reference image in the x-y plane, with which the image F_{xy} taken in the x-y plane by the detector 2.1 has to be concordant
   and
R_{yz}(z, y, m_{yz}) for the reference image in the y-z plane, with which the image taken in the y-z plane by the detector 2.2 has to be concordant.

The object is recognized to be right if a satisfying amount of data, e. g. 90%, are concordant for F_{xy} and R_{xy} as well as for F_{yz} and R_{yz}, respectively. The images of the dermal ridges can be described by recognition functions of the form F(x, y, z, m).

For the arrangement depicted in FIG. 1, the function
F_{xy}(x, y, m_{xy})

describes the image taken by the detector 2.1 in the x-y plane and the function
F_{yz}(z, y, m_{yz})

describes the image taken by the detector 2.2 in the y-z plane,

wherein m_{xy} and m_{yz} describe characteristic recognition attributes of dermal points in the respective planes.

### LIST OF REFERENCE NUMBERS

P Person

D Document

S Key

E Facility

1 Finger

2 Light detector

3 Light source
3.1 . . . 3.4 Light sources positioned adjacently to a light detector

1-10. (canceled)

11. A method for verifying access authorization of persons to a facility, wherein each person possesses a document having a carrier material applied thereto, the carrier material including biometric data of an owner of the respective document and at least one identifiable body containing readable data, the method comprising:
touchlessly acquiring the readable data from each identifiable body within a defined operating range using an acquisition unit;
transferring the acquired readable data from the acquisition unit to the facility;
automatically loading the biometric data corresponding to each person for whom the readable data is transferred from a central memory storage to into a device internal memory storage;
performing an identification of each person and determining the authorization of each person to possess the respective document at the facility.

12. The method as recited in claim 11, wherein the loading is performed by the facility.

13. The method as recited in claim 11, wherein the facility is a gambling machine in a casino and wherein the persons are gamblers.

14. The method as recited in claim 11, further comprising generating a dataset of the identifiable body and transferred the dataset to the central memory storage.

15. The method as recited in claim 11, wherein the facility is a gambling machine in a casino and wherein the gambling machine and several further gambling machines are located within reach and linked to the central memory storage.

16. The method as recited in claim 11, wherein the identifiable body includes a radio chip mounted on the carrier material.

17. The method as recited in claim 11, wherein the document is disposed in one of a portable radio and a telephone set.

18. The method as recited in claim 17, wherein the portable radio or telephone set is connectable to a socket mounted at the gambling machine.

19. The method as recited in claim 11, wherein the identification of the person is performed by analyzing a fingerprint of the person at the facility.

20. The method as recited in claim 11, wherein the document is an identity card, and wherein the biometric data includes at least one of a photograph, a fingerprint of the owner, and an access right.

21. The method as recited in claim 11, wherein the document includes a rechargeable value transponder.

22. A method as recited in claim 11, wherein the performing of the identification includes:
illuminating an object using a light source;
acquiring at least two images of the object using optical scanning from at least two different directions simultaneously;
determining numerical parameters using digital image processing;
calculating a three-dimensional model of the object from the at least two images;
comparing the three-dimensional model with a reference model; and
determining the identification to be right if the numerical parameters are simultaneously concordant with the reference model within predetermined tolerances.

23. A method as recited in claim 22, further comprising previously creating the n the reference model using a plurality of images of the object.
